(19) United States
(12) Patent Application Publication
(10) Pub. No.: US 2011/0012750 A1
(43) Pub. Date: Jan. 20, 2011

(54) TRACKING THE MOVEMENT OF RFID READER-EQUIPPED DEVICES WITHIN A DEFINED AREA USING BARRIER SERIES

(76) Inventor: Hyun-Chul Jung, Busan (KR)

Correspondence Address: AMPACC Law Group, PLLC, 6100 219th Street SW, Suite 580, Mountlake Terrace, WA, 98043, US

(21) Appl. No.: 12/667,858

(22) PCT Filed: Feb. 22, 2008
(86) PCT No.: PCT/KR2008/001059

§ 371 Date: Jan. 5, 2010

(30) Foreign Application Priority Data
Jul. 9, 2007 (KR) 10-2007-0068838

(51) Int. Cl. G06K 7/01; G08B 5/22

(52) U.S. Cl. 340/825.49; 340/10.52

(57) ABSTRACT

Disclosed is a method for checking and managing the history of movement of equipment, which operates in a target space divided into at least two areas, by using a number of RFID tags. The target space (e.g. warehouse) is divided into at least two areas, and RFID tags are installed on the boundary line between the areas at a short interval. When equipment (e.g. forklift) provided with a RFID reader moves across the boundary line and recognizes the RFID tags installed on the boundary line, the computer system recognizes that the equipment has moved from an area to another and displays the result of recognition to the outside so that the operator can finally recognize in which area of the target space the equipment or the object (cargo) carried by it exists in real time.

### TECHNICAL FIELD

The present invention relates to a method for checking and managing the history of movement of equipment operating in a space of interest, which is divided into at least two areas, by using a number of RFID tags.

### BACKGROUND ART

An Radio Frequency IDentification (hereafter, referred to as “RFID”) system is a kind of a radio communication system which consists of RFID, an antenna, a reader and a writer, wherein the RFID is moved by attaching to an article and moves, and performs a radio communication with an antenna fixed on the ground or a building. The reader controls communication between an antenna and RFID or performs a protocol exchange between an upper-level device, such as a computer, and RFID. Recently, there are many readers with a built-in antenna.

RFID is one of the constituents of an RFID system. The RFID is required to satisfy the following three conditions concurrently: (i) the size should be convenient for carrying; (ii) information should be stored in an electronic circuit; and (iii) the communication should be made by non-contact communication. Accordingly, although a floppy disc, a magnetic card, a contact IC card, etc. are convenient to store data and to be carried, they are not included in RFID. Although RFID broadly covers a non-contact IC card (RF card), it generally refers to an RF tag.

RFID is used to identify an article, to which an RFID tag is attached, and information on the article. In other words, when and where a product exists, required information can be taken out and new information can be wrote down, if necessary. When using RFID, we can save time spending in inquiring an information center of required information and receiving the response. Further, this RFID system has advantages, such as an easy distributed process of information and simplification of information system. In particular, an automatic identification means used in an automatic processing line should resist harsh environments, such as vibration and impact, water and oil, high temperature and dust, etc., under which RFID is suitable. Additionally, RFID is more suitable for the cases where batch production is made on one production line, and a frequent exchange of information on a target object is required. Although RFID was used as a substitution for a bar code at a relatively early logistics stage, such as a production process or a logistics center, it tends to be gradually extended to a final distribution stage, such a distribution stage.

The RFID tag refers to RFID attachable to an article, and is valuable in the field of an FA (Factory Automation). An RFID tag largely consists of a chip and an antenna, and has a completed shape through an encapsulation process to protect the RFID tag. The RFID tag has various shapes, such as a credit card, a stick, a coin, a label, etc., depending on an encapsulation method so that a user can select a shape suitable for his/her purpose. The RFID tag is independently separated and manufactured in the shape of piece. Hereinafter, an RFID tag previously manufactured in the shape of piece is referred to as an ‘Independent RFID tag’.

### DISCLOSURE

### Technical Problem

The present invention provides a method for checking and managing the history of movement of equipment operating in a space of interest, which is divided into at least two areas, by using a number of RFID tags.

### Technical Solution

In accordance with an aspect of the present invention, there is provided a method for identifying a history of movement of equipment in a target space by using barrier series, the method including the steps of (a) dividing the target space into a number of areas and assigning respective areas with unique area IDs to be computerized by a computer system; (b) arranging a number of RFID tags on each boundary line between the areas obtained in step (a) at an identical interval to install a first barrier series with a number corresponding to each boundary line; (c) arranging a number of RFID tags at an identical interval at a predetermined distance from the first barrier series stalled in step (b) in parallel with the first barrier series to install a second barrier series with an identical number as the first barrier series; (d) assigning the first and second barrier series installed in steps (b) and (c) with unique series IDs, respectively, to be computerized by the computer system; (e) recognizing RFID tags belonging to the first and second barrier series at a discrete time interval and transmitting resulting information to the computer system by using a RFID reader mounted on a body of the equipment when the equipment moving in the target space crosses a boundary line between two areas constituting the target space; and (f) confirming from and to which areas of the target space the equipment has moved based on the information received in step (e) and displaying results of confirmation by the computer system.

In short, according to the present invention, the target space (e.g. warehouse) is divided into at least two areas, and RFID tags are installed on the boundary line between the areas at a short interval. When equipment (e.g. forklift) provided with a RFID reader crosses the boundary line and identifies the RFID tags installed on the boundary line, the computer system recognizes that the equipment has moved from an area to another area, and displays the result of recognition to the outside so that the operator can finally recognize in which area of the target space the equipment or the object (e.g. cargo) carried by it exists in real time.

### ADVANTAGEOUS EFFECTS

The present invention is advantageous in that, by installing RFIDs in the target space in a simple manner, the operator can easily recognize how equipment or an object carried by the equipment is moving in the target area, as well as in which area the equipment or object exists currently, in real time.

### DESCRIPTION OF DRAWINGS

The foregoing and other objects, features and advantages of the present invention will become more apparent from the following detailed description when taken in conjunction with the accompanying drawings in which:

FIG. 1 shows a target space divided into three areas, each of which is given a unique area ID;

FIG. 2 shows a first barrier series installed on the boundary lines between three separate areas;

FIG. 3 shows a second barrier series installed in parallel with the first barrier series;

FIG. 4 shows first and second barrier series assigned with unique series IDs, respectively;

FIG. 5 shows the movement of equipment from area A to area B in the target space;

FIG. 6 shows the movement of equipment from area A to area C in the target space;

FIG. 7 shows the movement of equipment from area B to area A in the target space;

FIG. 8 shows the movement of equipment from area C to area A in the target space;

FIG. 9 shows the movement of equipment from area B to area C in the target space; and

FIG. 10 shows the movement of equipment from area C to area B in the target space.

### MODE FOR INVENTION

Hereinafter, exemplary embodiments of the present invention will be described with reference to the accompanying drawings.

In step 100, the target space is divided into a number of areas, which are assigned with unique area IDs, respectively, to be computerized by a computer system. The target space is preferably divided into areas having a straight boundary so that areas can be arranged and managed in the target space more easily, or RFID tags can be installed on the boundary line more conveniently. FIG. 1 exemplifies a target space divided into three areas, which are assigned with unique area IDs, respectively.

In step 200, a number of RFID tags are arranged at an identical interval on the boundary lines between the areas, into which the target space has been divided in step 100, so that first barrier series, the number of which corresponds to respective boundary lines, are installed. In step 300, a number of RFID tags are arranged at an identical interval at a predetermined distance from the first barrier series installed in step 200 in parallel with the first barrier series so that second barriers are installed with the same number as the first series. In step 400, the first and second barrier series installed in steps 200 and 300 are assigned with unique series IDs, respectively, to be computerized by a computer system.

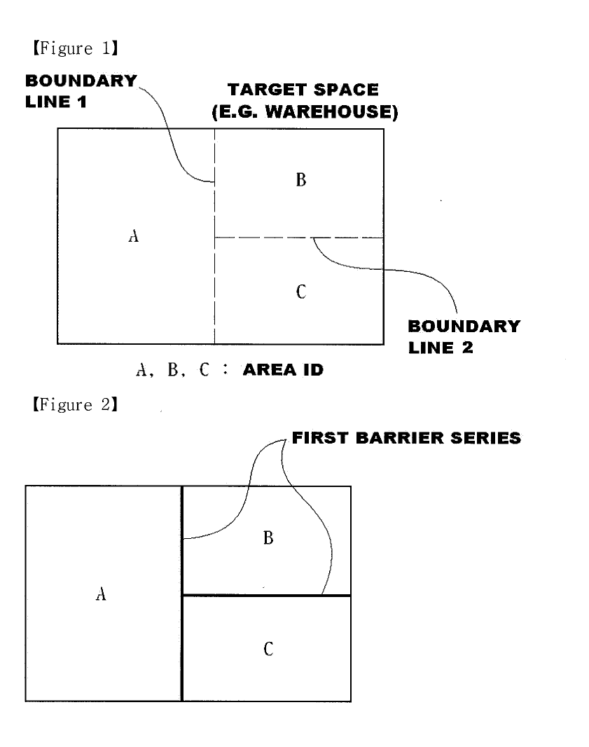

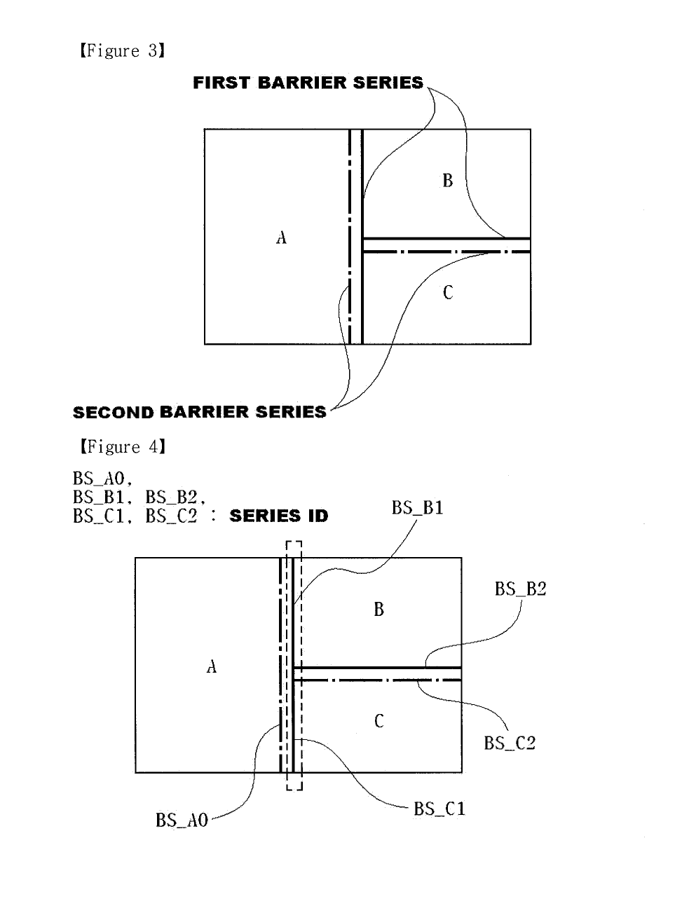

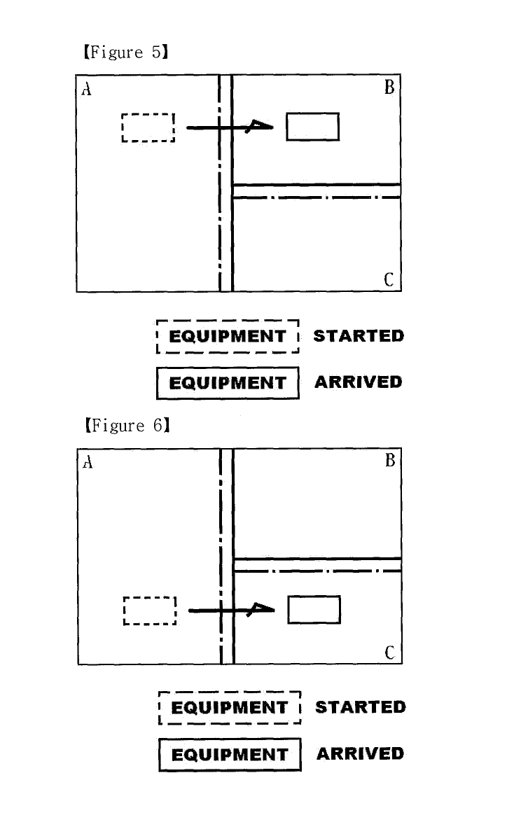

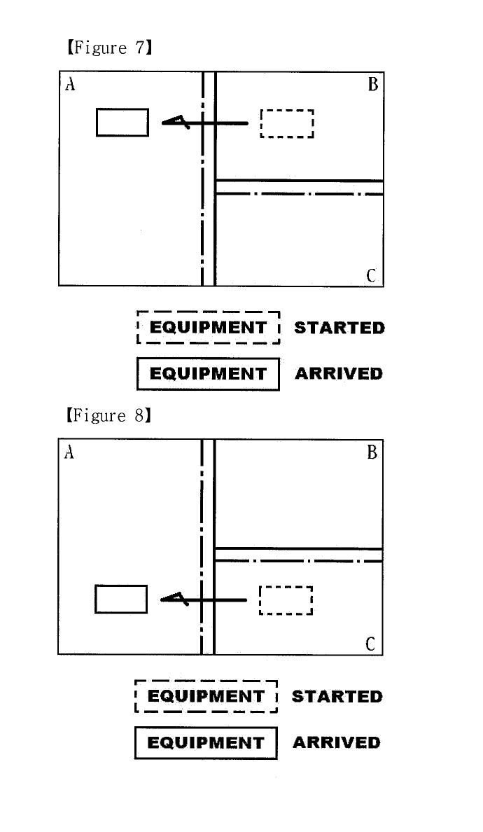

FIG. 2 shows first barrier series installed on the boundary lines of three separate areas, FIG. 3 shows second barrier series installed in parallel with the first barrier series, and FIG. 4 shows first and second barrier series assigned with unique series IDs, respectively.

In step 500, equipment adapted to operate in the target space moves across a boundary line between two areas constituting the target space, recognizes RFID tags belonging to the first and second barrier series at a discrete time interval by using the RFID reader mounted on the body, and transmits the corresponding information to the computer system. In step 600, the computer system confirms from and to which areas of the target space the equipment has moved with reference to the information received in step 500, and displays the result of confirmation.

More particularly, if the RFID reader mounted on the equipment has recognized the first barrier series and then the second barrier series in step 600, the computer system indicates that the equipment has moved from an area bordered by the first barrier series to an area bordered by the second barrier series. If the RFID reader mounted on the equipment has recognized the second barrier series and then the first barrier series, the computer system indicates that the equipment has moved from an area bordered by the second barriers series to an area bordered by the first barrier series.

As used herein, a barrier series refers to a series of RFID tags encoded and arranged at an identical interval so that the order can be identified. Preferably, the interval between the RFID tags constituting a barrier series is sufficiently small so that the RFID reader mounted on the equipment can always read at least one RFID tag at whatever angle the equipment moves across the series.

Although RFID tags constituting a barrier series may be encoded in the same manner, different barrier series must have different series IDs to be distinguished from each other.

A barrier series is installed by encoding RFID tags one after another on the spot and installing them while measuring the distance between them. Although there is no physical connection between the RFID tags, they are preferably arranged at an identical interval along a straight line.

The reason a pair of barriers series (i.e. first and second barrier series) are installed on each boundary line through steps 200 and 300 is to recognize in what direction the equipment provided with the RFID reader has moved across the barrier series.

More particularly, if only one barrier series (first barrier series) has been installed as shown in FIG. 2, there is no knowing whether the equipment has moved from area B to area C or vice versa. This is because, if there is only one barrier series, the computer system is just informed that the same barrier series has been read, regardless of the direction of movement of the equipment. If the system can know in which area the equipment has initially been, the direction of the equipment moving across the barrier series could be inferred. However, this requires additional means for identifying the starting point of the equipment.

Therefore, if a pair of barrier series (first and second barrier series) are installed as shown in FIG. 3, the direction of movement of the equipment can be identified without additional means, as will now be described in detail.

Referring to FIG. 3, first and second barrier series are successively installed on the boundary line between areas B and C (steps 200 and 300). The first and second barrier series are preferably as close as possible to each other for better efficiency, but not to such an extent that they are recognized simultaneously by a single RFID reader.

If the equipment moves from area B to area C, the RFID reader mounted on the equipment necessarily recognizes the first barrier series first and then the second barrier series. If the equipment moves in the opposite direction, the RFID reader mounted on the equipment necessarily recognizes the second barrier series first and then the first barrier series. As such, the order of recognizing the first and second barrier series indicates the direction of movement of the equipment. The same is true of other relationships among areas A, B, and C.

When the first and second barrier series are assigned with unique series IDs in step 400, the following case should be considered. Any two boundary lines between areas, into which the target space has been divided in step 100, may intersect with each other, and the first or second barrier series installed on one of the boundary lines may intersect with the first or second barrier series installed on the other boundary line. Therefore, both portions of the first or second barrier series, which are divided by the point of intersection, are preferably assigned with different series IDs.

More particularly, referring to FIGS. 1 and 4, the boundary lines 1 and 2 intersect with each other, and the first barrier series installed along the boundary line 1 intersect with the first and second barrier series installed along the boundary line 2. Therefore, both portions of the first barrier series (indicated by a dotted box) installed along the boundary line 1, which are divided by the point of intersection, are assigned with different series IDs BS_B1 and BS_C1, respectively.

This configuration clearly tells whether the equipment has moved from area A to area B or from area A to area C. It is also possible to easily recognize whether the equipment has moved from area B to area A or from area C to area A.

Particularly, if the RFID reader mounted on the equipment has recognized the series ID in the order of BS_A0→BS_B1, it is clear that the equipment has moved from area A to area B (FIGS. 4 and 5); if the RFID reader mounted on the equipment has recognized the series ID in the order of BS_A0→BS_C1, it is clear that the equipment has moved from area A to area C (FIGS. 4 and 6); if the RFID reader mounted on the equipment has recognized the series ID in the order of BS_B1→BS_A0, the equipment has moved from area B to area A (FIGS. 4 and 7); and, if the RFID reader mounted on the equipment has recognized the series ID in the order of BS_C1→BS_A0, it is clear that the equipment has moved from area C to area A (FIGS. 4 and 8).

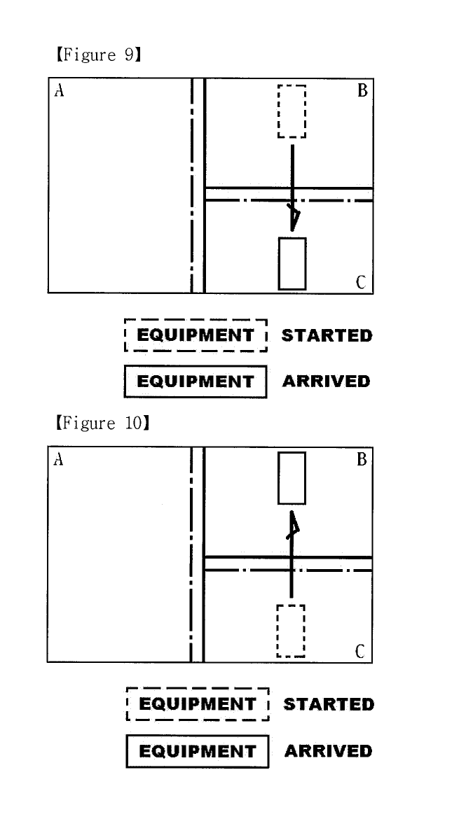

In addition, if the RFID reader mounted on the equipment has recognized the series ID in the order of BS_B2→BS_C2 in FIG. 4, it is clear that the equipment has moved from area B to area C (FIGS. 4 and 9); and, if the RFID reader mounted on the equipment has recognized the series ID in the order of BS_C2→BS_B2, it is clear that the equipment has moved from area C to area B (FIGS. 4 and 10).

In step 600, the computer system preferably displays the current position and trajectory of the equipment on the screen after the equipment has stopped moving, so that the operator on the spot can recognize in real time how the equipment or the object carried by the equipment is moving in the target space and in which area it currently exists.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention, RFIDs are installed in the target space in a simple manner to enable the operator to easily recognize how the equipment or the object carried by the equipment is moving in the target space and in which area it currently exists. The present invention thus has practical and economical values and applicability in the field of circulation/management or warehousing.

1. A method for identifying a history of movement of equipment in a target space by using barrier series, the method comprising the steps of:
(a) dividing the target space into a number of areas and assigning respective areas with unique area IDs to be computerized by a computer system;
arranging a number of RFID tags on each boundary line between the areas obtained in step (a) at an identical interval to install a first barrier series with a number corresponding to each boundary line;
arranging a number of RFID tags at an identical interval at a predetermined distance from the first barrier series stalled in step (b) in parallel with the first barrier series to install a second barrier series with an identical number as the first barrier series;
(d) assigning the first and second barrier series installed in steps (b) and (c) with unique series IDs, respectively, to be computerized by the computer system;
(e) recognizing RFID tags belonging to the first and second barrier series at a discrete time interval and transmitting resulting information to the computer system by using a RFID reader mounted on a body of the equipment when the equipment moving in the target space crosses a boundary line between two areas constituting the target space; and
(f) confirming from and to which areas of the target space the equipment has moved based on the information received in step (e) and displaying results of confirmation by the computer system.

2. The method as claimed in claim 1, wherein, in step (a), the target space is divided into a number of areas having straight boundaries.

3. The method as claimed in claim 1, wherein, in step (b), an operator encodes RFID tags one after another on the spot and installs the RFID tags while measuring the distance between the RFID tags.

4. The method as claimed in claim 1, wherein, in step (b), a first barrier series is installed in a straight line shape.

5. The method as claimed in claim 1, wherein, in step (b), a number of RFID tags are arranged at an identical short interval so that the RFID reader can always read at least one RFID tag at whatever angle the equipment moving in the target space crosses the first barrier series.

6. The method as claimed in claim 1, wherein, in step (c), an operator encodes RFID tags one after another on the spot and installs the RFID tags while measuring the distance between the RFID tags.

7. The method as claimed in claim 1, wherein, in step (c), a second barrier series is installed in a straight line shape.

8. The method as claimed in claim 1, wherein, in step (c), a number of RFID tags are arranged at an identical short interval so that the RFID reader can always read at least one RFID tag at whatever angle the equipment moving in the target space crosses the second barrier series.

9. The method as claimed in claim 1, wherein, in step (c), the distance between the first and second barrier series when the second barrier series is installed at a predetermined distance from the first barrier series is large enough to avoid simultaneous recognition of the first and second barrier series by the RFID reader.

10. The method as claimed in claim 1, wherein, in step (d), when two of the boundary lines between the areas obtained in step (a) intersect with each other and when the first or second barrier series installed along one boundary line intersects with the first or second barrier series installed along the other boundary line, both portions of the first or second barrier series separated by a point of intersection are assigned with different series IDs.

11. The method as claimed in claim 1, wherein, in step (f), when the RFID reader mounted on the equipment recognizes the first barrier series and then the second barrier series, the computer system indicates that the equipment has moved from an area bordered by the first barrier series to an area bordered by the second barrier series, and when the RFID reader mounted on the equipment recognizes the second barrier series and then the first barrier series, the computer system indicates that the equipment has moved from the area bordered by the second barrier series to the area bordered by the first barrier series.

12. The method as claimed in claim 1, wherein, in step (f), the computer system displays a current position and a movement trajectory of the equipment on a screen when the equipment stops moving.
